(19) United States
(12) Patent Application Publication
(10) Pub. No.: US 2024/0066848 A1
(43) Pub. Date: Feb. 29, 2024

(54) BIAXIALLY ORIENTED PHA-RICH COMPOSITE FILM

(71) Applicant: TORAY PLASTICS (AMERICA), INC., North Kingstown, RI (US)

(72) Inventors: Shichen DOU, North Kingstown, RI (US); Joshua R. CLOUTIER, North Kingstown, RI (US)

(21) Appl. No.: 18/174,857

(22) Filed: Feb. 27, 2023

Related U.S. Application Data
(60) Provisional application No. 63/402,574, filed on Aug. 31, 2022.

(51) Int. Cl. B32B 27/36; B32B 7/027; B32B 27/08; B32B 27/18

(52) U.S. Cl. CPC B32B 27/36; B32B 7/027; B32B 27/08; B32B 27/18; B32B 2250/03; B32B 2250/244; B32B 2264/102; B32B 2270/00; B32B 2307/308; B32B 2307/31; B32B 2307/406; B32B 2307/414; B32B 2307/516; B32B 2307/518; B32B 2307/54; B32B 2307/5825; B32B 2307/702; B32B 2307/704; B32B 2307/7163; B32B 2307/7244; B32B 2307/746; B32B 2439/70

(57) ABSTRACT

A biaxially oriented multi-layer composite film comprises a PHA-rich core layer and a heat sealant layer and a second outer skin layer. The core layer comprises a PHA resin at an amount of more than 50 wt % of a total weight of the core layer and a modifier X, the modifier X includes PLA, PLA copolymers, PBSA and PCL; the heat sealant layer comprises a PLA resin and a modifier Y, the modifier Y including PBSA and PCL resins is at an amount of about 20 wt % to 95 wt % of the total weight of the heat sealant layer. The composite film has low SIT and improved home compostability.

### CROSS REFERENCE OF RELATED APPLICATION(S)

This application claims priority from U.S. provisional application No. 63/402,574, titled as “BIAXIALLY ORIENTED BIODEGRADABLE COMPOSITE FILM” filed on Aug. 31, 2022, which is incorporated herein by reference in its entirety.

### FIELD OF THE INVENTION

This invention relates to a biaxially oriented multi-layer PHA-rich composite film with a formulation to improve the processability, mechanical, and heat seal properties while the biodegradability and compostability are controlled at the level required home composting.

### BACKGROUND OF INVENTION

In recent years, interest in “Greener” packaging and “End of Life” has been strongly developing. Packaging materials based on biologically derived polymers are increasing due to concerns with plastic pollution, renewable resources, raw materials, and greenhouse gas generation. Bio-based plastics are believed to help reduce reliance on petroleum, reduce production of greenhouse gases, and eliminate plastic pollution, and can be biodegradable or compostable as well. bio-based plastics such as polylactic acid (PLA) and polyhydroxyalkanoates (PHA) derived from a renewable resource are the most popular and commercially available for packaging film applications. Polybutylene succinate (PBS) or polybutylene succinate-co-adipate (PBSA) is a partially bio-based biodegradable polymer. Other biodegradable polymers such as poly(ε-caprolactone) (PCL) and polybutylene adipate terephthalate (PBAT) that are petroleum-based biodegradable polymers are largely available at the time of this writing to address the concerns of plastics pollution and “End of Life” of disposable single use packaging.

Biaxially oriented polylactic acid (BOPLA) films are transparent with a high clarity and high gloss as well as high modulus, which are very desirable for printing graphics with high visual appearance and for forming rigid container such as stand pouches of a single materials packaging. One example could be a two-layer coextruded film structure in which a base or core layer including a crystalline PLA and a thinner “skin” layer including amorphous PLA is coextruded upon one side of the core layer and then biaxially oriented into a film. The amorphous PLA layer is often used to provide heat sealability to the film as it is non-crystalline; it has a glass transition temperature (Tg) of 56 to 60° C. much lower than the melting temperature of the semi-crystalline PLA resins in the core layer. PLA is the most inexpensive biodegradable polymer obtained from renewable source.

A couple obvious disadvantages of this conventional BOPLA packaging have been noted in the marketplace since it was commercialized. Firstly, BOPLA packaging due to its very high modulus results in extremely loud noise at about 95 decibels, which is harmfully loud and potentially damages ear hearing, compared to the noise level about 79 decibels for a conventional BOPP film packaging. Secondly, BOPLA packaging is only industrial compostable under a controlled temperature environment of 58±2° C. (ASTM D 5338-15), this approach has a drawback due to the limited public availability of industrial composting facilities.

To compost food waste as well as food packaging together under lower temperatures or in a shorter period of composting time, it is needed to develop a new food packaging using non-conventional materials. TUV Austria Group offers a test method called HOME COMPOSTING (AS 5810-2010 or “OK COMPOST HOME—CERTIFICATION, 2019 VERSION”) to evaluate the biodegradability and compostability of new bioplastics compostable films. The test method is based on the test procedures of ASTM D5338-15 (industrial composting), but the composting temperature is set at 25±5° C. instead, the test temperature is kept below 30° C. for the duration of the test. Home composting can be conducted in the backyard which is available for most of consumers in North America.

Heat resistance (thermal stability) is one of the most important properties of food packaging film. The heat resistance of BOPLA film is lower than that of BOPP film due to the difference in crystallinity (Xc) and melting temperature (Tm). The heat resistance of a biaxially oriented PHA-rich composite film is even lower than that of a BOPLA film due to the characteristics of the lower Tg, Tm and Xc of PHA bioplastics as well as modifiers used in making the composite film. Aside from the orientation ratio and heat set temperature, the heat resistance relies on the Tg, Tm, and Xc of the composite film, especially, higher Tm and Xc are desirable to improve heat resistance. Having a good heat resistance is the key for a composite film to perform well on existing industrial printing, lamination and packaging machines designed for BOPP packaging films used for dried snack food packaging. A composite film with improved heat resistance and lowered heat seal temperature could circumvent poor performance such as film wrinkling (due to high thermal shrinkage) as well as heat distortion (due to poor heat resistance) around the heat-sealed areas, namely the end seals of the bag and the back seal of the bag. All those defects in quality are unacceptable to food packaging companies.

Except for lower seal initiation temperature (SIT), heat seal strength can also significantly impact the heat seal performance. High plateau seal strength is the key to improve the overall heat seal performance in terms of the hermeticity of a sealed package. Hermeticity means that there are no voids and tunnels formed inside the sealed area and no leaks due to the failure resulted from weak heat seal strength. It is often desirable to have heat sealable films and laminations with a low sealing initiation temperature, broaden heat sealing temperature window and higher plateau heat seal strength.

Polyhydroxyalkanoates (PHAs) are a group of renewable biodegradable polyesters that are synthesized by mainly microorganisms from renewable sources including sugars obtained from lignocellulosic biomasses, agricultural wastes, starches, and vegetable oils; PHAs are completely biodegradable and converted into CO2 and H2O in soil and oceans. PHAs are certified compostable bioplastics that could be used for making compostable food packaging films. However, a few disadvantages including their poor mechanical properties, poor thermal stability, long crystallization time, high production cost as well as incompatibility with conventional thermal processing techniques have limited their competition with traditional synthetic plastics or their application as ideal bioplastics. To overcome these drawbacks, PHAs must be modified to meet the performance required for specific food packaging applications.

A PHA-rich composite is defined as that the content of PHAs is higher than 50 wt % of the total weight of the composite. Therefore, a PHA-rich composite film has a core layer comprising PHA resins not less than 50 wt % of the total weight of the core layer.

The properties of PHA-rich composites or alloys or blends have been intensely studied for the applications required by packaging materials, particularly, industrial compostable, home compostable, soil biodegradable, freshwater biodegradable, and marine biodegradable, however, none of them have demonstrated the preparation of biaxially oriented PHA composite film in a tenter frame process and showed improved performance in heat sealing and heat resistance.

Narancic et al. published their studies on the biodegradation of individual biopolymers and their blends as well (Article: Environ. Sci. Technol. 2018, 52, 10441-10452). The authors disclosed in their study that a blend of PLA/PHB at the ratio of 80/20 is not home compostable at the home composting test temperature. However, PHB could be a biodegradation promoter in the home compostable composites of PHB/PHO (85/15) and PHB/PBS (85/15) as the content of PHB in the composite is favorable for biodegradation at the test temperature since PHO and PBS are not home compostable resins.

U.S. Pat. No. 9,238,324 describes a multi-layer biaxially oriented PLA composite film (PLA-rich composition) that is a heat sealable film with a significantly reduced noise level, which is related to a reduction in film modulus. The modulus level of the oriented film was reduced by incorporating low Tg flexible modifiers including biodegradable biopolymer A and elastomer E into the core layer as sound dampening materials. The content of the modifiers A and E in the core layer is at about 20 wt % to 40 wt % of the total weight of the core layer. The low Tg flexible biopolymers include PHA, PCL, PBAT, PBS, and PBSA. Petroleum-based elastomers includes Kraton™ FG 1924 and Biomax® SG 120. The invented film was only designed for industrial composting application, and the SIT was not reduced to meet the required of a soft composite packaging film.

U.S. Pat. No. 9,150,004 describes a method of reducing the seal initiation temperature (SIT) of a biaxially oriented PLA film by modifying the amorphous PLA sealant layer with low Tg biodegradable bioplastics. The SIT of the inventive BOPLA film was reduced from 195° F. for PLA control film to as low as 170° F. for the invented film. However, the plateau seal strength was in a range of about 290 to 370 Win which was not as high as a level at which there is a function of heat sealing hermeticity.

USPTO Pub. No.: US2022/0033649A1 describes a biodegradable polymeric composition comprising 5 wt % to 95 wt % PHA resin and about 5 wt % to 95 wt % at least one biodegradable polymer selected from PBS, PBSA, PLA, PBAT, PCL, thermoplastic starch (TPS), cellulose esters, and mixtures thereof; and 0.1 to 5 wt % nucleating agent. An amount of 5 to 15 wt % plasticizer can further be incorporated into the biodegradable polymeric composition. The biodegradable composition is both industrial and home compostable, and suitable for the application of making packaging articles. However, the invention does not disclose the methods of making heat sealable film suitable for snack food packaging, particularly, heat seal properties are required for the packaging.

USPTO Pub. No.: US2021/0277226A1 describes a biodegradable composition (PLA-rich composition) comprising PLA resins, plasticizers, compatibilizers, and enzymes. Lactic acid oligomers (LAO) and compatibilizers significantly increase the tear resistance and elongation at break of bioplastic films. Enzymes well dispersed into PLA resins can improve PLA-biodegrading activity. All inventive PLA-based film articles show high toughness and high depolymerization rate. Higher degradation rate could indicate that enzymes in the presence promote the biodegradation of PLA resin. However, the invention does not teach how to make a heat sealable film for snack food packaging which is home compostable.

Therefore, there is a long felt need for preparation of a biaxially oriented PHA-rich composite film for snack food packaging with desirable processability, mechanical properties, improved heat sealability, and home compostability by using cost-effective PLA resins as a main modifier, wherein PLA degradation in the PHA-rich environment can be achievable through PHA enzymatic degradation under ambient temperature after modification.

### SUMMARY OF INVENTION

Inventors demonstrate the preparation of a biaxially oriented PHA-rich composite film for snack food packaging with desirable processability, mechanical properties, improved heat sealability, and home compostability by using cost-effective PLA resins as a main modifier, wherein PLA degradation in the PHA-rich environment can be achievable through PHA enzymatic degradation under ambient temperature after modification.

In this invention, PHAs are modified in the core layer of a biaxially oriented composite film by using other biodegradable polymers including PLA, PLA copolymers, PCL, PBAT, PBS, PBSA, chemically modified starch, cellulose derivatives, and different PHA-type blends and mixtures thereof. An embodiment relates to a multi-layer composite film comprising a PHA-rich core layer (B), a heat sealant layer (C) and a second outer skin layer (A); wherein the PHA-rich core layer comprises PHA resin and non-PHA modifier X, wherein the core layer has an amount of PHA resin more than 50 wt % of the total weight of the core layer; wherein the non-PHA modifier X has a glass transition temperature of Tg≤60° C.; wherein an amount of the modifier X is less than 50 wt % of the total weight of the core layer; wherein the heat sealant layer comprises a PLA resin and a modifier Y; the modifier Y has a glass transition temperature of Tg≤0° C. and a peak melting temperature of 56° C.≤Tm≤90° C.; wherein the film is sequentially oriented in machine direction (MD) and then in transverse direction (TD) or the film is simultaneously oriented in both machine and transverse direction.

In an embodiment, wherein the core layer comprises PHA resin at an amount of more than 50 wt % of a total weight of the core layer.

In an embodiment, wherein the PHA resin includes semi-crystalline PHA resins and amorphous PHA resins such as PHB, PHBV, PHB-co-3HV, PHB-co-3HHx, PHB-co-3HO, and PHB-co-4HHx or mixtures thereof.

In an embodiment, the modifier X comprises PLA, PLA copolymers, PBS, PBSA, PCL, PBAT, and other biodegradable polymers or mixtures thereof with a glass transition temperature of Tg≤60° C.

In an embodiment, wherein the modifier X includes PLA resin at an amount of less than 50 wt % of a total weight of the core layer.

In an embodiment, wherein the PLA resin in the core layer comprises semi-crystalline PLA resin, amorphous PLA resin and PLA copolymer resin or mixtures thereof.

In an embodiment, the modifier X further comprises an amount of less than 5 wt % petroleum-based polymeric modifier with a glass transition temperature of Tg≤10° C.

In an embodiment, the core layer further comprises a processing aid, a chain extender, a nucleating agent, a biodegradable promoter, a plasticizer, inorganic particles and/or slip additives or mixtures thereof,

In an embodiment, the inorganic particles comprise nanoclay, talc, CaCO3 or TiO2 or mixtures thereof.

In an embodiment, the heat sealant layer comprises a PLA resin in an amount of about 5 wt % to 80 wt % of the total weight of the heat sealant layer.

In an embodiment, the PLA resin in the heat sealant layer comprises semi-crystalline PLA resin, amorphous PLA resin and PLA copolymers or mixtures thereof.

In an embodiment, the modifier Y comprises polybutylene succinate-co-adipate (PBSA) or polycaprolactone (PCL) or other biodegradable polymers with a glass transition temperature of Tg≤0° C. and a melting peak temperature of 56 to 90° C. or mixtures thereof.

In an embodiment, the amount of the PCL is about 0 wt % to about 35 wt % of the total weight of the heat sealant layer.

In an embodiment, the amount of the PBSA is about 20 wt % to about 95 wt % of the total weight of the heat sealant layer.

In an embodiment, the weight of the sealant layer polymer is an amount of 5 wt % to 25 wt % of the total weight of the core layer.

In an embodiment, the second outer skin layer has the same materials as the core layer.

In an embodiment, the second outer skin layer comprises materials different from that of the core layer.

In an embodiment, the film comprises a core layer, a heat sealable layer, and a non-heat sealable layer.

In an embodiment, the film comprises a core layer and two outer layers which are heat sealable.

In an embodiment, wherein the film optionally comprises either one or two tie-layers which is located between the core layer and the two outer skin layers.

In an embodiment, the outer skin layer is either a layer of receiving print ink, metal deposition or barrier coating.

In an embodiment, the outer skin layers comprise an amount of antiblock particles with a spherical size of about 2 to 6 μm.

In an embodiment, a loading of the antiblock particles in the outer skin layers is in the range of 100 to 5000 ppm of a total weight of the heat sealant layer.

In an embodiment, the heat sealant layer comprises a migratory slip additive.

In an embodiment, a loading of the migratory slip additive is in the range of 500 to 5000 ppm of a total weight of the heat sealant layer.

In an embodiment, the film is configured to be a print film has the core layer comprising migratory particles in an amount of 500 to 1000 ppm.

In an embodiment, the film is configured for metallization has the core layer devoid of migratory particles.

In an embodiment, a thickness of the film is about 10 μm to about 50 μm.

In an embodiment, the thickness of the film is about 15 μm to about 25 μm.

In an embodiment, the outer skin layers have a thickness of about 1 μm to about 5 μm.

In an embodiment, the heat sealant layer has the thickness of about 2 μm to about 4 μm.

In an embodiment, the skin layers have a thickness of about 1 μm to about 3 μm.

In an embodiment, the skin layers have a thickness of about 1 μm to about 2 μm.

In an embodiment, the transesterification between components is achieved by processing conditions including temperature profiles, pre-compounding, and screw designs.

In an embodiment, discloses the method of making PHA-rich composite film suitable for snack food packaging in which heat seal properties are required for the packaging.

In an embodiment, the invention provides a method of making PHA-rich composite film for food packaging which has improved home compostability

In an embodiment, the invention provides a packaging film feasible for printing, coating, and metallization.

In an embodiment, the invention provides a method of making PHA-rich high barrier film for snack food packaging.

In an embodiment, the present invention provides a method to make a PHA-rich composite film using polymeric modifiers to improve the processability, mechanical properties, heat sealing properties and home compostability of a food packaging film.

### BRIEF DESCRIPTION OF THE FIGURES

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 shows the heat seal curves of the coextruded films.

FIG. 2 shows the hot tack curves of the coextruded films.

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more”. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, two or more elements are “integral” if they are comprised of the same piece of material. As defined herein, two or more elements are “non-integral” if each is comprised of a different piece of material.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

“Polymer” is a macromolecule compound prepared by polymerizing monomers of the same or different type. Polymer includes homopolymers, copolymers, terpolymers, tetrapolymer, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on.

In an embodiment, polymers could include additional additives. The polymer is interchangeable used as “resin”.

“Biaxially oriented film” is a film that is stretched in both machine and transverse directions, producing molecular chain orientation sequentially or simultaneously in two directions. A biaxially oriented film has much higher tearing strength in machine direction in comparison with a blown film which is mainly oriented in machine direction. In addition, a blown film can also have high heat shrinkage in machine direction. The biaxially oriented film could be a single layer or multi-layer composite film.

“Biodegradable Bioplastics” or “Biodegradable Film” or “Compostable Composite Film” or similar refer to polymeric materials that are ‘capable of undergoing decomposition into carbon dioxide, methane, water, inorganic compounds, or biomass in which the predominant mechanism is the enzymatic action of microorganisms, that can be measured by standardized tests, in a specified period of time, reflecting available disposal condition’. In an embodiment, more than 50%, 60%, 70%, 80%, 90% of the film could be degraded by the microbial action. In an embodiment, the film could be fully degraded by the microbial action. In an embodiment, the biodegradable film has a home composting property as described by AS 5810-2010 standard.

“Semi-crystalline” or “semicrystalline” refers to a polymer that exhibits highly organized and tightly packed molecular chains. “Semi-crystalline” may be simplified as “crystalline” as in comparison with “amorphous”. The crystalline regions are called spherulites and can vary in shape and size with amorphous regions existing between the crystalline regions. As a result, this highly organized molecular structure has a defined melting temperature point.

“Crystallinity” refers to the degree of highly organized order structure excluding the fraction of amorphous phases in a resin. Typically, a semi-crystalline resin has a degree of crystallinity in the range of from 10 wt % to 80 wt % of the total weight of the resin.

“Total crystallinity” refers to the crystallinity of a polymer blend or composite containing more than one component. The degree of the crystallinity of each component can be measured by using differential scanning calorimetry (DSC). The degree of the crystallinity of a polymer blend or composite can also be determined by using DSC experiment. If a composite consists of 50 wt % PHBV, 20 wt % PHB-co-3HHx and 30 wt % amorphous PLA resins, wherein the crystallinity of the PHBV is about 78 wt % and the crystallinity of the PHB-co-3HHx is about 40 wt %, the total crystallinity of the composite is about 47 wt % which can be obtained from calculation.

“Amorphous resin” has a randomly ordered molecular structure which does not have a sharp melting temperature point. Such a resin often softens or solidifies as its temperature is changed to above Tg or below Tg.

“Glass transition temperature, Tg” is a thermal property associated with the long-range segmental mobility of polymer chains. As the temperature increases above Tg, a resin starts softening; as the temperature drops below Tg, the resin starts solidifying.

Tg governs the rigidity, toughness and flexibility of a polymer or polymer composite in a specific temperature range. Under ambient temperature condition, a polymer film with a Tg higher than ambient temperature, it is rigid, otherwise it is flexible as it has a Tg below ambient temperature. Either DSC or DMA (dynamic mechanical analysis) can be used to determine the Tg of polymers, polymer blends, composites, and multilayer plastic films.

“Low Tg flexible biopolymers” in the invention refer to those biopolymers have a Tg less than 10° C., including PBSA, PBS and PCL, PBAT, and PHA resins, but PHB and PHBV are excluded. Although PHB or PHBV biopolymers have a Tg lower than 10° C., they are rigid biopolymers due to their high crystallinity.

“Modifier” refers to materials that are added into the resin to improve the properties of a biaxially oriented composite film such as but not limited to improving heat-sealability, mechanical strength (flexibility, modulus, tensile strength, elongation, etc.), thermal stability, biodegradability, compostability, optical properties, and surface properties and so on. In an embodiment, modifier could be added in the resin during an appropriate step of polymerization, melt compounding, dry blending and coextrusion processes at a desirable amount.

“Modifier X” is a non-PHA based modifier used to modify the core layer. Modifier X comprises biopolymers having a glass transition temperature of Tg≤60° C. It includes for example but not limited to PBS, PBSA, PCL, PBAT, PLA, and PLA copolymers such as PLA-co-GA, PLA-co-3HP, and PLA-co-ε-CL copolymers.

“Modifier Y” is flexible biopolymers used to modify the heat sealable layer. The biopolymers have a glass transition temperature of Tg≤0° C. and a melting point between 56 to 90° C. Modifier Y includes but not limited to polybutylene succinate-co-adipate (PBSA) or polycaprolactone (PCL) or other biodegradable polymers or mixtures thereof.

“Transesterification” refers to the conversion of one ester to another. Transesterification on polyesters (such as a blend of PLA and PHA resins or a blend of PLA and PCL resins) is a reaction to exchange the group OR″ of a polyester with the group OR′ of another polyester (OR′ and OR″ are polyester chain segments or polyester chains). The reaction occurs in the molten state at the ester bond of one polyester with or without the presence of added acid or base catalysts or metal salt catalysts and in situ produce firstly block copolymers and finally random copolymers. The reaction is a useful method for blending noncompatible polyesters and is also responsible for modification effects to improve the compatibility, mechanical properties (such as toughness and modulus), biodegradability, and compostability of a biopolymer composite. For example, the home compostability of a random PLA-co-PHB or PLA-co-ε-CL copolymer can be greatly improved in comparison with that of PLA homopolymers.

“PHA-rich” is defined when the content of PHAs is more than 50 wt % in the total weight of the layer. Therefore, a PHA-rich composite film has a core layer comprising PHA resins not less than 50 wt % of the total weight of the core layer.

“PLA resin” is polymerized from a racemic mixture of L- and D-lactides with the level of (L) and (D) monomers being variable. The crystallinity of PLA resins (including L-dominated PLLA and D-dominated PDLA) can be controlled by the ratio of L and D monomers in PLA chain structure.

“Peak melting temperature” refers to the average melting temperature (Tm) of the crystallites of a semi-crystalline polymer. The Tm of a semi-crystalline polymer is obtained by measuring a polymer sample well annealed at its crystallization temperature using DSC at a heating rate of 10° C./min.

“Heat seal temperature” refers to the heat sealing jaw temperatures at which a specific level of seal strength is obtained for a specific plastic film. The range of heat sealing temperature can be determined by plotting the seal strength versus seal jaw temperature.

“Heat sealing hermeticity” refers to the airtight seal of a plastic package which is created by a heat sealing process using a heat sealer armed with two jaws. Airtight means that no defects such as wrinkles, tunnels and voids are created inside the seals or at the corners of a package bag. Broad heat sealing window and high plateau seal strength importantly affect the hermetic seal integrity of a package.

“Shrink film” refers to a plastic film which shrinks tightly over whatever it is covering due to high heat shrinkage rate when heat is applied to it. Shrink film can be used for either packaging film or shrinkable label film. Usually, a shrink film has a percentage of the amount of shrink measured in both the machine direction (MD) and the transverse direction (TD) above 20%.

“Non-shrink film” usually refers to a plastic film which is stretchy and requires no heat application. Stretching tension and cling of a plastic film provide tightness required for packaging.

“Heat resistant film” refers to a plastic film which has heat shrinkage rate less than 10% in both machine direction and transverse direction when processing heat such as metallizing, printing, coating, laminating or heat sealing is applied to it. The characteristics of heat resistance is required for dried snack food packaging.

Compatibility and biodegradation of PLA/PHB blends were reviewed by Arrieta et al., The review article was published in Materials (Basel), 2017, September, 10(9)1008 (Article: on the Use of PLA-PHB Blends for Sustainable Food Packaging Applications). PLA/PHB blends prepared by solvent casting over the range of compositions of 0 to 100% by weight for each component are immiscible, while the miscibility of PLA and PHA blend made by extrusion are improved through increasing the melt processing temperature up to 200° C. The improved miscibility was attributed to the transesterification which occurred between PLA and PHB chains and in situ produced PLA-block-PHB copolymers, compatibilizing immiscible PLA and PHB components. For the PLA/PHB blend at the proportion of 75/25, small PHB spherulites were well dispersed in amorphous PLA phase; while at the proportion of 50/50 and 25/75, crystalline PHB forms a continuous phase, PLA component forms separated sea-island phase depending on the ratio of PLA/PHA components.

The PHB component in PLA/PHB blend speeds up the biodegradability of PLA component at room temperature, PHB degradation is mainly enzymatically degraded by various enzymes which are secreted by microorganisms in contact with PHB, those enzymes (including proteinase K, serine protease, lipase, esterase, and alcalase) can accelerate PLA degradation at room temperature due to the faster disintegration of PHA/PLA structure. Commonly, PLA degradation is considered to undergo a non-enzymatic but hydrolytic degradation since microorganisms associating PLA in nature cannot secret enzymes to break PLA long chains into PLA oligomers which can then be enzymatically degraded into CO2 and H2O. A different view was reported by Huang et al. reported (Biomacromolecules, 2020, 21, 3301-3307), proteinase K embedded in either solution-cast or extrusion-cast PLA film sample can accelerate the PLA degradation at the conditions of temperature 37° C. and pH value 8.5 in 50 mM Tris-HCL buffer (pH=8.5) solution, this enzymatic degradation forms small holes and cavities observed the surface and inside bulk of PLA film samples, characterized by SEM images and measured the weight loss of the PLA film samples.

In an embodiment, PLA/PHB blend with a higher PHB fraction associates more microorganisms and secretes more enzymes, which speeds up PLA enzymatic biodegradation under lower temperatures.

Materials and Properties

In an embodiment, Polyhydroxyalkanoates (PHA) resin has a copolymer structure of poly((3HB)n-co-(mHZ)(1-n)), where H=hydroxy; B=butylene; m is the position number of hydroxy group on the carbon chain of alkanoic acid (m=3 or 4 or 5); Z is the alkanoate in the copolymer (Z=Valerate (V), Hexanoate (Hx), Octanoate (O), and Decanoate (D) or mixtures thereof); n is the mole ratio of 3HB and (1−n) is the mole ratio of mHZ in the copolymer structure. Both the mole ratio (3HB/mHZ) and the structure of mHZ dominate the basic properties of PHA resins, especially, the crystallinity and melting temperature of the PHA resins. As n=1, the PHA resin is a PHB homopolymer. PHB homopolymer has a Tg of 9° C. and a melting temperature of 175 to 178° C. It is a very rigid biopolymer due to its high crystallinity. PHA resins have a Tg in the range of −44° C.≤Tg≤9° C. and a Tm of in the range of about 120 to 178° C. (Appl. Sci. 2017, 7, 242, herein reference is listed for convenience). Amorphous PHA resins comprise a high mole ratio of mHZ monomer so that the PHA copolymers has a Tg less than ≤−10° C., they are very rubbery biopolymers. Common engineering PHA biopolymers include PHB, PHBV, PHB-co-3HHx, PHB-co-4HHx, PHB-co-3HO, and PHB-co-3HD.

An example of PHBV resins include TianAn Enmat™ Y1000P, poly(3-hydroxybutyrate-co-3-hydroxyvalerate) (PHB-co-3HV or PHBV). An amount of from about 0.5 to 1 mol % 3hydroxyvaleric acid comonomer (3HV) obtained from petroleum-based chemicals as a precursor was added into feedstock in fermentation process to synthesize the copolyester of PHBV. The short side chain (ethyl group CH2CH3) of 3HV can incorporate into PHB crystals, leading to a high melting point of 175° C. and a high crystallinity (78%) according to the data obtained from differential scanning calorimetry (DSC) experiment. Y1000P has a glass transition temperature of about 2° C. and a melt flow index 8 to 15 g/10 min., and a density of 1.25 g/cm3. Y1000P is a very rigid biopolymer due to its high crystallinity. A reversed extrusion temperature profile is preferably needed for extruding the PHBV resin for the sake of preventing from significant thermal degradation, preferably, an amount of low Tm flexible biopolymers, amorphous biopolymers, and plasticizers or mixtures thereof could be blended into the PHBV resin in the core layer in extrusion to facilitate PHBV melting and eliminate its thermo-mechanically induced degradation.

In an embodiment, PHA resins with a side chain longer than three carbons are reported in the article published by Noda et. al. (book chapter: Nodax™ Class PHA Copolymers: Their Properties and Applications; Book: Plastics from Bacteria pp 237-255). The monomers with a longer chain in PHA resins include 3-hydroxyoctanoate (3HO), 3-hydroxyhexanoate (3HHx), and 3-hydroxydecanoate (3HD). Noda et. al. reported that the crystallinity of those PHA resins with longer side chain is in the range of 35 to 42% (FIG. 8 of the article); Those PHA resins listed in the art have a glass temperature of −2.5 to 2.5° C. (FIG. 9); and a melting temperature of 125 to 145° C. (FIG. 7 of the article). However, the authors also reported that those PHA resins have Young's modulus at the levels of oriented HDPE films (FIG. 12 of the article), which is much lower than that of BOPP film used in snack food packaging.

In recent practice of “End of Life”, oriented HDPE film has been noted that it is insufficient in both tensile strength and modulus to be a good packaging material to replace the current BOPP packaging materials in the market. Optimal Young's modulus for desirable food packaging needs to reach the modulus levels of BOPP films. In comparison, the crystallinity of homopolypropylene resins used in making food packaging films in the market is about in the range of 60 to 70%, which is much higher than that of PHA resins (35 to 42%) with longer side chains. In addition, the melting temperature of homopolypropylene is in the range of 160 to 170° C., which is much higher than that of flexible PHA resins (125 to 145° C.) with longer side chain. Both the lower crystallinity and low melting temperature of flexible PHA resins (Tg is about in the same as that of homopolypropylene, about −5 to 5° C.) with longer side chain result in lower heat resistance and higher heat shrinkage.

In an embodiment, optimal tensile strength and Young's modulus are required for snack food packaging. The tensile strength and stiffness/flexibility of the composite film can be controlled by balancing the ratio of rigid/flexible components in the core layer. As the content of rigid PHA resins such as PHB and PHBV in the core layer is more than 40 wt %, flexible biopolymers could be used as modifier in the core layer to improve the flexibility of the composite film. Reversely, the content of flexible PHA resins such as PHB-co-3HHx, PHB-co-3HD and PHB-co-3HO in the core layer is more than 40 wt %, rigid biopolymers such as PLA could be used in the core layer as modifier to improve the stiffness and modulus of the composite film.

In an embodiment, PLA resin is considered as a rigid biopolymer which is available at large commercial scale with a relative low cost. Examples include NatureWorks Ingeo™ PLA4032D and PLA4043D or PLA2003D or TotalEnergies Corbion Luminy® LX575 and LX175. These resins have a melt flow rate of about 3.9-4.1 g/10 min. at 190° C./2.16 Kg test condition, a melting temperature of about 145-170° C., a glass transition temperature of about 55-60° C., a density of about 1.25 g/cm3. Molecular weight Mw is typically about 200,000 g/mole; Mn typically about 100,000 g/mole; polydispersity about 2.0. PLA4032D and LX575 has a melting point of about 165-173° C., which are more preferred crystalline PLA resins for thermal resistance application.

In an embodiment, Ingeo™ PLA4043D and Luminy® LX175 has a melting point of about 145-152° C., lower Tm melting temperature of those PLA resins have the advantages of the capability of melting at lower extrusion temperatures as blended with biopolymers with poor thermal stability such as PHA resins. PLA resins with a Tm of about 150° C. such as LX175 and PLA4043D melt earlier compared to those PLA resins with a Tm of about 165° C. such as LX575 and PLA40432D before PHA resin melts during extrusion. Molten PLA resins can lubricate extrusion and facilitate the melting of PHB or PHBV resin having a Tm in the range of from 170 to 178° C., as a result, the extent of PHBV thermal degradation can be eliminated.

In an embodiment, the crystallinity of commercial semi-crystalline PLA resins with a Tm in the range of 145 to 168° C. is in the range of about 35 wt % to 45 wt % resulted from controlling the ratio of L and D enantiomers that are used in polymerization.

In an embodiment, amorphous PLA resins include NatureWorks Ingeo™ 4060D and TotalEnergies Corbion Luminy® LX975. Those resins have a melt flow index of about 3 to 6 g/10 min. measured at the condition of 2.16 Kg/190° C., and a glass transition temperature Tg of about 52-60° C. (softening temperature), heat seal initiation temperature of about 93° C., a density of about 1.24 g/cm3. Molecular weight Mw is about 180,000 g/mole. As it has been well known in the art that there are no melting temperatures for amorphous PLA resins. As amorphous PLA resins are heated to their glass transition temperature Tg around 56° C., the PLA chains can flow, and form entanglements, which create seals (solidifying) as the PLA chains are cooled to the temperatures lower than Tg 56° C.

In an embodiment, PLA copolymers include but not limited to lactide-rich copolymers such as poly(lactide-co-glycolide) (PLA-co-GA), poly (lactide-co-3hydroxypropionate) (PLA-co-3HP), and poly(lactide-co-ε-caprolactone) (PLA-co-ε-CL) copolymers. The comonomers such as glycolide, 3hydroxypropionate, and ε-caprolactone copolymerized with L and D enantiomers so that those comonomers can be inserted into PLA backbone to improve the flexibility and compostability of PLA copolymer resins. The PLA copolymers can be either semi-crystalline or amorphous, depending on the ratio of the D, L enantiomers as well as non-lactide monomers.

In an embodiment, low Tg flexible home compostable biopolymers include polybutylene succinate-co-adipate (PBSA) resins and polycaprolactone (PCL) resins.

In an embodiment, suitable example of PBSA resins could be but not limited to PTT MCC BioPBS™ FD92PM, which has a glass transition temperature (Tg) −47° C. and a melting temperature (Tm) 87° C., and a melt flow index 4 g/10 min. at 2.16 Kg/190° C. standard condition.

In an embodiment, suitable example of PCL resins could be but not limited to Ingevity CAPA®6500D or CAPA®6800D, which has a glass transition temperature (Tg) about −60° C. and a melting temperature (Tm) about 58° C. The melt flow index is 18 g/10 min. for CAPA6500D and 2.4 g/10 min. for CAPA6800D, tested with 2.16 kg load and 1″ PVC die at 160° C. Those biodegradable polymers are certified for both industrial composting and home composting by TUV Austria Group.

In an embodiment, Poly(butylene adipate-co-butylene-terephthalate) (PBAT) resin is also a low Tg flexible biopolymer. One example of PBAT resins is BASF Ecoflex® C1200, which has a density of about 1.25 g/cm3, a glass transition temperature of about −30° C., a melt flow index of 2.7 to 409 g/10 min. at the condition of 2.16 Kg/190° C. However, The PBAT melts between 50° C. and 150° C. with a flat peak at about 120° C. and has a very low crystallinity of only around 15%. a Vicat softness of about 91° C., it is a very rubbery and soft biopolymer. To a certain extent, it can be considered as amorphous biopolymer in application. Ecoflex® C1200 can provide good effects on modulus reduction and sound dampening. PBAT is not TUV-certified for home compostable application.

In an embodiment, multi-functional epoxidized or maleic anhydride grafted polymeric resins can chemically react with the chain end groups (—COOH) of polyesters. Suitable examples of multi-functional reactive polymeric resins with the functional groups include amorphous maleic anhydride modified SEBS Kraton™ FG 1924 polymer and Dow Biomax® SG 120 resin.

In an embodiment, Kraton™ FG 1924 polymer is an amorphous elastomer having a glass transition temperature of −90° C. for its polybutadiene blocks and a Tg of 100° C. for its polystyrene blocks, the weight percentage of polystyrene blocks is only about 17 wt %. Therefore, F G 1924 is a very rubbery material with excellent flexibility for modification at a low loading amount to achieve good noise dampening effect.

In an embodiment, Biomax SG 120 is a type of epoxidized ethylene-acrylate copolymers or terpolymers (non-biodegradable polyolefin elastomers) with contemplated structures of ethylene-n-butyl acrylate-glycidyl methacrylate, ethylene-methyl acrylate-glycidyl methacrylate, ethylene-glycidyl methacrylate, or blends thereof. This additive has a density of about 0.94 g/cm3, a melt flow rate of about 12 g/10 min. at 190° C./2.16 kg test condition, a melting point of about 72° C., and a glass transition temperature of about −55° C.

In an embodiment, spherical antiblocks are necessary for film making. The spherical antiblocks includes crosslinked silicone polymer such as Tospearl® grades of polymethlysilsesquioxane of nominal 2.0 and 3.0 μm sizes and sodium aluminum calcium silicates of nominal 3 μm or 5 μm in diameter (such as Mistui Silton® JC-30 and JC-50).

In an embodiment, PLA10A is an antiblock masterbatch comprising 5 wt % Silton® JC-30 particles and 95 wt % amorphous PLA carrier resin Luminy® LX975, it was made through toll compounding.

In an embodiment, migratory slip additives may also be contemplated to control COF properties such as fatty amides (e.g. erucamide, stearamide, oleamide, etc.) or silicone oils ranging from low molecular weight oils to ultrahigh molecular weight polysiloxane gums.

### Film Formulation

In an embodiment, the multilayer film is a three-layer film comprising a PHA-rich core layer sandwiched by two outer skin layers, the core layer is considered as the base layer to provide the bulk strength and mechanical properties of the oriented composite film.

In an embodiment, the core layer (B) comprises PHA resin at an amount of more than 50 wt % of the total weight of the core layer and non-PHA based modifier X at an amount of less than 50% of the total weight of the core layer.

In an embodiment, the PHA resins in the core layer include semi-crystalline PHA resins with a glass transition temperature of Tg≤10° C. such as PHB, PHBV, PHB-co-3HHx, and PHB-co-3HO, and PHB-co-3HD resins, and optionally a small amount of amorphous PHA resins.

In an embodiment, the modifier X in the core layer comprises biopolymers including PBA, PBSA, PCL, PLA as well as PLA copolymers such as PLA-co-3HP, PLA-co-ε-CL and PLA-co-GA resins having a glass transition temperature of Tg≤60° C. and a melting temperature Tm in the range of from 56° C.≤Tm≤165° C., preferably, the Tm is in the range of from 56 to 155° C.

In an embodiment, the core layer (B) comprises a desirable amount of low Tg flexible biopolymers working together with the resins in the heat seal layer (C) to improve the SIT, hermeticity, and plateau heat seal strength.

In an embodiment, preferably, a total amount of the adequate low Tg flexible biodegradable polymers added in the core layer is in the range of 5 wt % to 25 wt % of the total weight of the core layer. The low Tg flexible biopolymers including amorphous PHAs, PBSA, PCL and PBAT can enhance the plateau heat seal strength and broadens the heat seal range typically provided by amorphous PLA heat seal resins. They can also reduce the modulus and so that they can dampen the noise of a composite film if desired.

In an embodiment, rigid biopolymers such as but not limited to PHB, PHBV, and PLA resins in the core layer do not improve the heat seal properties regarding SIT and plateau seal strength.

In one embodiment, the core layer (B) can include processing aids, antioxidants, plasticizers, nucleating agents, inorganic particles, fillers, lubricants and slip additives.

If desired, cavitating agents could be added to the core layer (B) such that upon biaxial orientation, voids are formed within this layer, thus rendering the film a matte or opaque and often, pearlescent white appearance. Such cavitating agents may in inorganic particles such as calcium carbonate, talc, or other minerals; or polymeric cavitating agents such as polystyrene, cyclic olefin copolymer, or other polymers. Titanium oxides may also be incorporated with the cavitating agent to provide a brighter white appearance.

In an embodiment, petroleum-based functional rubbery elastomers such as Kraton™ FG polymer and BIOMAX SG 120 at an amount not more than 5 wt % of the total weight of the core layer could be added into the core layer as modifier to improve the compatibility between the components in the core layer and the flexibility of the composite film.

In an embodiment, a small amount of chain extenders, plasticizers, nucleating agents, slip additives or mixtures thereof could be added into the core layer as modifier to improve the processability of the composite film.

In an embodiment, the heat sealable layer comprises PLA resin at an amount of 5 to 80 wt % and modifier Y at an amount of 20 to 95 wt % of the total weight of the heat seal layer.

In one embodiment, the modifier Y in the heat seal layer comprises PBSA at an amount of 20 to 95 wt % and PCL at an amount of 0 to 30 wt % of the total weight of the heat seal layer, and a desirable amount of antiblocks and slip additive for slip and blocking control.

In an embodiment, the modifier resins PBSA and PCL in the desirable loading range have been found not only to sufficiently lower the seal initiation temperature, broaden the heat sealing temperature window, and enhance the plateau seal strength, but also maintain the processability during film-making as well as to help keep the sealant layer home compostable since amorphous PLA resin is not home compostable. Both PBSA and PCL can crystallize much faster than semi-crystalline PHA resins or PBAT resins, and they have a sharp crystallization peak, indicating less defect in the crystals of PCL and PBSA, as they cool in sealing process compared to PHA resins. Quick solidifying and crystallization provide a huge advantage to heat sealing performance and lowering heat sealing cycle time. In addition, both polymers also have the advantage of being fully biodegradable and home compostable and promoting the home compostability of amorphous PLA resins. This is important to maintain the overall biodegradability and/or compostability of the whole multi-layer film structure.

In an embodiment, the semi-crystalline biopolymeric resins PCL and PBSA have a melting temperature in the range of 56° C.≤Tm≤90° C. and a glass transition temperature lower than 0° C. (Tg≤0° C.). Therefore, the sealant layer can have a function of preventing from easy blocking in the hot weather conditions such as a summer season and improved SIT by at least 30° F. In the invention, the SIT is reduced from 193° F. (a SIT of amorphous PLA sealant layer in the PLA control film) to 160° F., the composting time of the heat sealant layer per AS 5810-2010 standard could be controlled to less than 12 months. The quick disintegration of the sealant layer resulted from improved compostability may help the compostability of the total film structure of a composite film product.

In an embodiment, the composite film comprises a second outer skin layer (A) on the top of the core layer (B), opposite the heat sealable layer (C) for use as a printing layer (i.e. print ink receiving layer) or metal receiving layer or coating receiving layer. This second outer layer can comprise either the same composite as in the core layer or a home compostable blend different from that in the core layer. The second outer skin layer (A) could also incorporate various additives such as antiblock particles for film-handling purposes.

In an embodiment, the heat sealable layer (C) can include an antiblock component selected from the group consisting of amorphous silicas, aluminosilicates, sodium calcium aluminum silicates, crosslinked silicone polymers, and polymethylmethacrylates to aid in machinability and winding and to lower coefficient of friction (COF) properties. Suitable amounts range from 0.03 to 2 wt % of the heat sealable layer and typical particle sizes of 2.0-6.0 μm in diameter, depending on the final thickness of this layer. A suitable amounts of slip additives can also be included at a amount in the range from 300 ppm to 10,000 ppm of the layer.

If desired, the layer (A) could also include the same or similar composition as the heat sealable layer (C), thus rendering the overall multi-layer film a two-side sealable film.

If desired, the outer skin layer (C) could also include the same or similar composition as that in the non-heat sealable layer (A), thus rendering the overall multi-layer film a three-layer non-heat sealable film.

If desired, all three layers of the film could comprise the same materials, thus rendering the overall multi-layer film a monolayer composite film.

In the embodiment of a three-layer coextruded film structure, the third layer (A) can include similar amounts of antiblock and slip additives as the respective core and heat sealable layers, although the amounts are likely to be optimized for performance. In this embodiment, it is not necessary for the core layer (B) to include antiblock particles (although migratory additives may still be included in the core layer as a reservoir from which such additives may migrate to the outer surface layers as desired).

In the case where the above embodiments are to be used as a substrate for vacuum deposition metallizing, in an embodiment, migratory slip additives not to be used as these types of materials may adversely affect the metal adhesion or metallized gas barrier properties of the metallized BOPLA film. It is thought that as the hot metal vapor condenses on the film substrate, such fatty amides or silicone oils on the surface of the film could vaporize and cause pin-holing of the metal-deposited layer, thus compromising gas barrier properties. Thus, only non-migratory antiblock materials should be used to control COF and web-handling.

In the case where the above embodiments are to be used as a printing film, in an embodiment, it may be advisable to avoid the use of silicone oils, in particular low molecular weight oils, as these may interfere with the print quality of certain ink systems used in process printing applications. However, this depends greatly upon the ink system and printing process used.

In an embodiment, the second outer skin layer (A) is preferable to discharge-treated for lamination, metallizing, printing, or coating. Discharge-treatment in the above embodiments can be accomplished by several means, including but not limited to corona, flame, plasma, or corona in a controlled atmosphere of selected gases. Preferably, in one variation, the discharge-treated surface has a corona discharge-treated surface formed in an atmosphere of CO2 and N2 to the exclusion of O2.

In an embodiment, the laminate film embodiments could further include a vacuum-deposited metal layer on the discharge-treated layer's surface. Preferably, the metal layer has a thickness of about 5 to 100 nm, has an optical density of about 1.5 to 5.0, and includes aluminum, although other metals can be contemplated such as titanium, vanadium, chromium, manganese, iron, cobalt, nickel, copper, zinc, gold, or palladium, or alloys or blends thereof.

In an embodiment, multi-layer biodegradable composite film was made using a process of coextrusion and sequential orientation. The coextrusion was conducted at temperatures of about 160° C. to 210° C. by pushing materials through a 12-inch wide die, cast at a casting speed of about 6 meter per minute (mpm) on a chill drum with temperatures controlled between 15° C. and 30° C. using an electrostatic pinner, and then oriented in the machine direction 2 to 3.5 times through a series of heated and differentially sped rolls controlled at about 50° C. to 65° C., followed by transverse direction stretching about 3 to 5.0 times in a tenter oven with temperatures controlled at about 75° C. to 90° C. and then annealed at about 90° C. to 140° C. to reduce internal stresses to minimize shrinkage and give a relatively thermally stable biaxially oriented sheet. It is also beneficial to relax about 5 to 15% of the maximum width of the tenter orientation in the stretching section.

In an embodiment, this invention provides a method to allow the production of improving the heat seal performance of a biaxially oriented PHA-rich composite film using biodegradable and compostable modifiers. Such a film method and composition can result in faster packaging speeds with less issues in distortion and heat-sealing failure while compostability.

In an embodiment, this invention relates to a multi-layer biaxially oriented PHA-rich composite film with a formulation to improve the processability, heat seal properties, mechanical properties, and compostability.

### Film Preparation

In an embodiment, the PHA-rich core layer (B) of the coextruded composite film is sandwiched by two outer skin layers: a heat sealable layer (C) and a second outer skin layer (A). The outer skin layers have a thickness after biaxial orientation of between 0.5 and 5 μm, preferably between 1.0 and 3.0 μm. The core layer thickness after biaxial orientation can be in the range of 10 to 100 μm, preferably 14 to 25 μm, and even more preferably 15 to 20 μm. The coextrusion process includes a multi-layered compositing die, such as three-layer die or even four-layer or five-layer die if tie layer structure is required for film design. In the case of a two-layer coextruded film, a two-layer compositing die can be used.

In an embodiment, the laminate film is produced via coextrusion of the heat sealable layer and the core layer and other layers if desired, through a compositing die whereupon the molten multilayer film structure is quenched upon a chilled casting roll system or casting roll and water bath system and subsequently oriented in the machine direction (MD) and/or transverse direction (TD) into an oriented multi-layer film. Machine direction orientation (MDO) rate is typically 2.0 to 3.5 times and transverse direction orientation (TDO) is typically 3.0 to 5.0 times in a polyester film line. A relaxation rate of 5 to 15% after TDO can be applied to the oriented film in TD for reducing heat shrinkage. Heat setting conditions in the TDO oven is extremely critical to minimize thermal shrinkage effects. Those are well-known processes and skills in the art.

In an embodiment in the current invention, examples were practiced on a film making line armed with a three-layer 12-inch-wide flat die for molding and capability of orientation in MD and then in TD. The main composition in the core layer is a PHA-rich biodegradable composite described earlier except those examples for comparison. The multi-layer laminate sheet was coextruded at extrusion temperatures designed for each layer, cast and pinned—using electrostatic pinning—onto a cooling drum whose surface temperature was controlled between 15° C. and 35° C. to solidify the non-oriented laminate sheet at a casting speed of about 7 to 11 mpm (meter per minute). The non-oriented laminate sheet was stretched first in the machine direction at about 40 to 65° C. at a stretching ratio of about 2 to about 3.5 times the original length, using differentially heated and sped rollers and the resulting stretched sheet is heat-set at about 40 to 50° C. on annealing rollers and cooled at about 30 to 40° C. on cooling rollers to obtain a uniaxially oriented laminate sheet. The uniaxially oriented laminate sheet is then introduced into a tenter oven at a line speed of about 25 to 38 mpm and preliminarily heated between 60° C. and 75° C., and stretched in the transverse direction at a temperature of about 75 to 95° C. at a stretching ratio of about 3 to 5 times the original width and then heat-set or annealed at about 90 to 140° C., preferably about 110 to 140° C., and more preferably about 120 to 140° C. for making a film with good heat resistance to reduce internal stresses due to the orientation and minimize shrinkage and give a relatively thermally stable biaxially oriented sheet. TD orientation rates were adjusted by moving the transverse direction rails in or out per specified increments based on the TD infeed rail width settings and width of the incoming machine-direction oriented film. The biaxially oriented film has a total thickness between 10 and 100 μm, preferably between 15 and 30 μm, and most preferably between 17.5 and 25 μm.

In an embodiment, after biaxial orientation, the film may optionally be passed through an on-line discharge-treatment system, such as corona, flame, plasma, or corona treatment in a controlled atmosphere as described previously to whatever desired surface energy. Typically, useful surface energy can be 36 to 50 dyne/cm. The film is then wound into a roll form through film winding equipment.

One embodiment is to offline coat a primer coating on the second outer layer (A) to improve the adhesion of barrier coating to the bulk film, and the surface smoothness. Suitable examples of primer coatings include polyurethane (PU) coating, polyacrylate coating, and polyethylenimine (PEI) coating. One embodiment is to coat a barrier coating on the top of primer layer. The barrier coating could be a waterborne barrier coating solution derivative from any polymers of PVOH, EVOH, PEI, PU, and mixtures thereof.

In an embodiment, the coextruded laminate is a heat sealable film printable on the surface layer opposite the heat sealable layer.

In another embodiment, the coextruded laminate is two-side heat sealable.

In an embodiment, the coextruded film is a heat sealable film with a second outer layer to receive a primer, or coating or vacuum-deposited metal layer or the combination thereof. Another embodiment is to directly metallize the discharge-treated surface opposite the heat sealable layer. Another embodiment is to metallize the coated barrier layer surface opposite the heat sealable layer. Another embodiment is to metallize the surface layer with barrier coating added onto the primer coating opposite the heat sealable layer.

In another embodiment, a protecting coating layer could be coated over the metal layer to prevent from potential metal cracking and further improve barrier properties.

In an embodiment, the unmetallized laminate sheet or coated primed sheet is first wound in a roll. The roll is placed in a vacuum metallizing chamber, preferably, the sheet is in-chamber pre-treated at a desirable energy level before the metal is vapor-deposited onto the discharge-treated metal receiving layer surface. The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer can have a thickness between 5 and 100 nm, preferably between 20 and 80 nm, more preferably between 30 and 60 nm; and an optical density between 1.5 and 5.0, preferably between 2.0 and 3.0. The metallized film is then tested for oxygen and moisture gas permeability, optical density, metal adhesion, metal appearance and gloss, heat seal performance, tensile properties, thermal dimensional stability, and can be made into a laminate structure.

This invention will be better understood with reference to the following examples, which are intended to illustrate specific embodiments within the overall scope of the invention.

### Example 1

The compositions of each layer of the coextruded composite films made in Examples are shown in Table 1. The temperature profile of extrusion system (extruder, pipe and die) for Examples 1 and 2 are shown in Table 2a; Examples 3 to 19 have the same temperature profile as that in Example 2. The process condition data includes the orientation ratio in machine direction (MDX) and in transverse direction (TDX), heat set temperature, and TD relaxation for all examples was shown in Table 2b.

TABLE 1
Formulations of the coextruded composite films made in Examples (“Ex.”)

| Layer | Example | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|
| 2nd outer layer | PLA10A | 0.3 | 0.6 | 0.6 | 0.6 | 0.6 | 0.6 | 0.6 | 0.6 | 0.6 | 1 | 1 |
| (A, cast side) -wt % | LX175 | | | | 99.4 | 99.4 | 99.4 | 99.4 | | | 99 | 99 |
| | LX975 | 15 | 49.4 | 49.4 | | | | | 49.4 | 49.4 | | |
| | FD92PM | | | | | | | | | | | |
| | CAPA6500D | | | | | | | | | | | |
| | PLA4043D | | 50 | 50 | | | | | 50 | 50 | | |
| | LX575 | 84.7 | | | | | | | | | | |
| Core layer (B) -wt % | LX575 | 85 | | | | | | | | | | |
| | LX975 | 15 | | | | | | | | | | |
| | PLA4043D | | 37 | 27 | | | | | 25 | 25 | | |
| | LX175 | | | | 36 | 36 | 36 | 36 | | | 50 | 60 |
| | Y1000P | | 60 | 70 | 60 | 60 | 60 | 60 | 70 | 70 | 50 | 60 |
| | B.SG120 | | 3 | 3 | 4 | 4 | 4 | 4 | 5 | 5 | | |
| 1st outer layer | PLA10A | 6 | 6 | 6 | 0.6 | 0.6 | 0.6 | 0.6 | 6 | 6 | 1 | 6 |
| (C, air side) -wt % | LX975 | 94 | 94 | 94 | | | | | 94 | 94 | 99 | 74 |
| | LX175 | | | | 99.4 | 99.4 | 99.4 | 99.4 | | | | |
| | FD92PM | | | | | | | | | | | |
| | CAPA6500D | | | | | | | | | | | 20 |

| Layer | Example | Ex. 12 | Ex. 13 | Ex. 14 | Ex. 15 | Ex. 16 | Ex. 17 | Ex. 18 | Ex. 19 |
|---|---|---|---|---|---|---|---|---|---|
| 2nd outer layer | PLA10A | 1 | 6 | 6 | 6 | 6 | 6 | 6 | 6 |
| (A, cast side) -wt % | LX175 | 99 | | 24 | 24 | 24 | 24 | | |
| | LX975 | | 24 | | | | | 24 | 24 |
| | FD92PM | | 60 | 70 | 70 | 70 | 70 | 60 | 60 |
| | CAPA6500D | | 10 | | | | | 10 | 10 |
| | PLA4043D | | | | | | | | |
| | LX575 | | | | | | | | |
| Core layer (B) -wt % | LX575 | | | | | | | | |
| | LX975 | | | | | | | | |
| | PLA4043D | | | | | | | | |
| | LX175 | 30 | 30 | 30 | 70 | 70 | 70 | 50 | 40 |
| | Y1000P | 70 | 70 | 70 | 30 | 30 | 30 | 50 | 60 |
| | B.SG120 | | | | | | | | |
| 1st outer layer | PLA10A | 1 | 6 | 6 | 6 | 6 | 6 | 6 | 6 |
| (C, air side) -wt % | LX975 | | 24 | 24 | 24 | 24 | 24 | 24 | 24 |
| | LX175 | 99 | | | | | | | |
| | FD92PM | | 60 | 60 | 60 | 60 | 60 | 60 | 60 |
| | CAPA6500D | | 10 | 10 | 10 | 10 | 10 | 10 | 10 |

TABLE 2a
The temperatures used in making the coextruded composite films in Examples
(“Ex.”), extruder B has five zones: Z 1 to 5; extruders A and C have
three zones: Z1 to 3. Pipe was separated into two zones: Z 1 and Z 2. Examples
3 to 19 have a temperature profile for extrusion like that in Example 2.

| | | Extrusion (° C.) | | | | | Pipe (° C.) | | | Die body |
|---|---|---|---|---|---|---|---|---|---|---|
| Example | Extruder | Z1 | Z2 | Z3 | Z4 | Z5 | Screen | Z1 | Z2 | (° C.) |
| Ex. 1 | A | 204 | 204 | 204 | | | 204 | 193 | 193 | 193 |
| | B | 193 | 204 | 204 | 204 | 204 | 204 | 193 | 193 | 193 |
| | C | 204 | 204 | 204 | | | 204 | 193 | 193 | 193 |
| Ex. 2 | A | 204 | 204 | 204 | | | 204 | 193 | 177 | 177 |
| | B | 182 | 182 | 199 | 182 | 166 | 177 | 171 | 171 | 177 |
| | C | 204 | 204 | 204 | | | 204 | 193 | 177 | 177 |

TABLE 2b
The process data of orientation ratio (MDX and TDX), heat
set temperature and TD relaxation used to make the coextruded
composite films in Examples (“Ex.”), a typical condition
of BOPP film is also listed here for reference.

| | | |
|---|---|---|
| Orientation ratio | Heat set | TD relax. |

| Example | MDX | TDX | Temp.(° C.) | % |
|---|---|---|---|---|
| BOPP | 4.8 | 10 | 160 | 5 |
| Ex. 1 | 2.6 | 6.0 | 121 | 5 |
| Ex. 2 | 3.0 | 4.5 | 104 | 10 |
| Ex. 3 | 2.8 | 4.5 | 104 | 10 |
| Ex. 4 | 2.3 | 3.5 | 82 | 5 |
| Ex. 5 | 2.3 | 4.8 | 93 | 5 |
| Ex. 6 | 2.3 | 4.8 | 116 | 5 |
| Ex. 7 | 2.3 | 4.8 | 127 | 5 |
| Ex. 8 | 2.8 | 4.5 | 88 | 10 |
| Ex. 9 | 2.8 | 4.5 | 104 | 10 |
| Ex. 10 | 2.8 | 4.5 | 104 | 10 |
| Ex. 11 | 2.5 | 4.0 | 127 | 10 |
| Ex. 12 | 2.8 | 4.5 | 104 | 10 |
| Ex. 13 | 2.8 | 4.5 | 104 | 10 |
| Ex. 14 | 2.5 | 4.5 | 104 | 10 |
| Ex. 15 | 2.5 | 4.5 | 127 | 10 |
| Ex. 16 | 2.5 | 4.5 | 138 | 10 |
| Ex. 17 | 2.5 | 4.5 | 146 | 10 |
| Ex. 18 | 2.5 | 4.0 | 127 | 10 |
| Ex. 19 | 2.8 | 4.5 | 138 | 10 |

A three-layer coextruded biaxially oriented PLA film (BOPLA) was made as control using sequential orientation on a 12-inch-wide flat die line as described previously, including non-heat sealable layer (A), a core layer (B), a heat sealable layer (C). The core layer was sandwiched between two outer skin layers. The PLA10A with 5 wt % JC-30 particles in 95 wt % LX975 carrier resin was added into outer skin layers for the purpose of COF control and anti-blocking. The content of JC-30 particles in the non-heat sealable outer layer (A) is about 150 ppm and the content of JC-30 antiblock in the heat seal layer (C) is about 3000 ppm.

The dry blended resins of the core layer and the outer skin layers were melt coextruded individually in extruders A (second outer layer, cast side layer), B (core layer) and C (first outer layer, heat sealant layer) at temperatures of about 204° C. The molten resins flowed through a set of screen pats and individual melt pipes set at temperature of 204° C. and then met inside the die body of a twelve-inch flat die set at temperature of 204° C., resulting in a curtain of molten resin. The temperatures of extruders (A, B, C) and die body were shown in Table 2a. The resin curtain was then cast on a chilled drum (set at temperature about 30° C.) using an electrostatic pinner. The formed cast sheet was stretched 2.6 times in the machine direction (MD) through rolls set at temperatures between 40° C. to 65° C. and then stretched 6.0 times in transverse direction (TD) in a tenter oven set temperatures 65 to 82° C. The resultant biaxially oriented film was subsequently annealed at 121° C. and then relaxed at 5% in TD, followed by discharge-treated on the surface of the non-heat sealable skin layer (A) opposite the heat sealable skin layer (C) via corona treatment. The film was then wound up in roll form. The conditions of MDX, TDX, heat set temperatures and TD relaxation were shown in Table 2b.

The total thickness of this film substrate after biaxial orientation was about 80 gauges (G) or 0.8 mil or 20 μm. The thickness of the respective heat sealable resin layer (C) after biaxial orientation was about 8 G (2.0 μm). The thickness of the core layer (B) after biaxial orientation was about 68 G (17.0 μm). The thickness of the non-sealable skin layer (A) was about 4 G (1.0 μm).

### Example 2

Example 1 was repeated while the process conditions and formulations were changed. The core layer was changed to a PHA-rich core layer comprising 60 wt % of PHBV Y1000P resin, 37 wt % of PLA4043D PLA resin and 3 wt % of Biomax SG 120 (shown in Table 1). An optimum extrusion temperature profile (shown in Table 2a) was used in extrusion. The design of the extrusion temperatures was attempted to facilitate the chemical reactions (in case Biomax SG 120 is used) and transesterification reactions between PHBV and PLA resins and in the meantime to eliminate PHA thermal degradation during extrusion. The polymer melt temperature of the extruder B was controlled at not higher than 165° C., at which thermal degradation observed for PHA resins starts. The extrusion temperatures of extruder A and C were higher than that of extruder B. The temperature of the die body was set at about 177° C. Generally, the residence time of polymer melt between the entrance of the extruder B and the exit of the die body was estimated at about 5 to 10 minutes, varying with the rpm of extruder B and film thickness. Biomax SG 120 was added into the core layer for modifying film flexibility, toughness as well as the compatibility between PHA and PLA resin. The molten polymer melt was cast on a chilled set 30° C. to form a cast sheet with a width about 9.5 inches. The sheet was oriented in machine direction for 3 times and then in transverse direction for 4.5 times. The composite film was heat set at 104° C. and relaxed for 10% in TD and then corona-treated under conditions described previously. The thickness of each layer of the coextruded laminate film is about the same as that in Ex.1.

### Example 3

Example 2 was repeated with the same skin layer recipes. However, the content of PHBV Y1000P resin in the core layer (B) was increased to about 70 wt % and the content of PLA4043D resin was reduced to 27 wt %. MDX was slightly reduced from 3.0 to 2.8.

### Example 4

Example 2 was repeated by changing the recipes in the two outer layers, and the content of Biomax SG120 in the core layer was increased to 4 wt %. The PLA resins in both skin layers and core layer was changed to TotalEnergies Corbion LX175. The heat set temperature was set at 82° C., and the MDX and TDX were 2.3 and 3.5, respectively. TD relaxation was reduced from 10% to 5%.

### Examples 5 to 7

Example 4 was repeated except that the TDX was increased from 3.5 to 4.8. The heat set temperature was increased from 82° C. to 93° C., 116° C., and 127° C., respectively.

### Example 8

Example 3 was repeated except that the content of Biomax SG 120 in the core layer was increased from 3 wt % to 5 wt %, and the content of PLA4043D was reduced from 27 wt % to 25 wt %, and the heat set temperature was reduced from 104° C. to 88° C.

### Example 9

Example 8 was repeated except that the heat set temperature was increased from 88° C. to 104° C.

### Example 10

Example 4 was repeated with a few variations. The core layer was changed to comprise 50 wt % Y1000P PHBV resin and 50 wt % LX175 PLA resin. The two outer skin layers have the same non-heat sealable recipe. The MDX was changed from 2.3 to 2.8 and TDX was changed from 3.5 to 4.5. No Biomax SG 120 was added into the core layer for modification. The heat set temperature was increased from 82° C. to 104° C.

### Example 11

Example 10 was repeated except that the outer skin layer (C) was changed to a sealant layer formulation with an amount of 74 wt % LX975, and 20 wt % CAPA6500D and 6 wt % PLA10A. The core layer was changed to comprise 60 wt % Y1000P resin and 40 wt % LX175 resin. MDX was reduced from 2.8 to 2.5 and TDX was reduced from 4.5 to 4.0. The heat set temperature was increased from 104° C. to 127° C.

### Example 12

Example 10 was repeated except that the core layer formulation was changed to comprise 70 wt % Y1000P resin and 30 wt % LX175 resin. The heat set temperature was reduced from 127° C. to 104° C.

### Example 13

Example 12 was repeated except that the two outer layers were changed to a heat sealable formulation comprising 24 wt % LX975, 60 wt % FD92PM, and 10 wt % CAPA6500D, and 6 wt % PLA10A. The PHA-rich composite film is a two-side heat sealable film.

### Example 14

Example 13 was repeated except that the second outer layer on the cast drum side was changed to a formulation comprising 24 wt % LX175, 70 wt % FD92PM, and 6 wt % PLA10A. The sealability of the second outer skin layer (cast side) of the PHA-rich composite film was slightly reduced due to the addition of semi-crystalline LX175 resin. MDX was reduced from 2.8 to 2.5.

### Example 15

Example 14 was repeated except that the core layer formulation was changed to comprise 30 wt % Y1000P PHBV resin and 70 wt % LX175 PLA resin. In addition, the heat set temperature was increased from 104° C. to 127° C. Two out skin layers comprises 70 wt % of TUV-certified home compostable flexible resins, while the core layer comprises PHBV resin less than 50 wt %.

### Example 16 to 17

Example 15 was repeated except that the heat set temperature was increased from 127° C. to 138° C. and to 146° C., respectively.

### Example 18

Example 13 was repeated except that the core layer formulation was changed to comprise 50 wt % Y1000P PHBV resin and 50 wt % LX175 PLA resin. In addition, the heat set temperature was increased from 104° C. to 127° C. The composite film is a two-side heat sealable film with low Tg flexible biopolymers in the outer skin layers.

### Example 19

Example 18 was repeated except that the core layer formulation was changed to comprise 60 wt % Y1000P PHBV resin and 40 wt % LX175 PLA resin; the formulation of the second outer skin layer (cast side) was changed to comprise 70 wt % FD92PM, 24 wt % LX975 and 6 wt % PLA10A. In addition, the heat set temperature was increased from 127° C. to 138° C. The composite film is still a two-side heat sealable film with flexible biopolymers in the two outer skin layers, the loading of 10 wt % CAPA6500D in the cast side was replaced by using 10 wt % FD92PM for better heat resistance. The cast side skin layer should have better heat sealability compared to the cast side skin layer of the composite fin in Examples 14 to 17.

### Film Properties

The biaxially oriented coextruded PHA-rich composite films were tested for the properties of mechanical strength, tear resistance, heat shrinkage (heat resistance), heat sealing, optics and COF which are basic film properties required for snack food packaging films.

TABLE 3
Mechanical properties of the coextruded films
made in Examples (“Ex.”) as well as
the mechanical properties of BOPP film

| | Tensile | | | | | | Tear | | |
|---|---|---|---|---|---|---|---|---|---|
| | strength | | Elongation | | Modulus | | strength | | Tear |
| | (MPa) | | (%) | | (kMPa) | | (g/mil) | | strength |
| Example | MD | TD | MD | TD | MD | TD | MD | TD | MD/TD |
| BOPP | 115 | 234 | 176 | 30 | 1.7 | 2.5 | 7.5 | 6.4 | 1.2 |
| Ex. 1 | 121 | 182 | 133 | 64 | 3.5 | 5.8 | 18.9 | 13.2 | 1.4 |
| Ex. 2 | 117 | 123 | 113 | 85 | 3.2 | 3.4 | 10.6 | 9.7 | 1.1 |
| Ex. 3 | 95 | 122 | 147 | 62 | 3.4 | 3.9 | 10.4 | 8.8 | 1.2 |
| Ex. 4 | 89 | 155 | 160 | 43 | 2.9 | 3.8 | 15.5 | 15.8 | 1.0 |
| Ex. 5 | 75 | 147 | 137 | 48 | 3.0 | 3.9 | 17.6 | 15.7 | 1.1 |
| Ex. 6 | 70 | 128 | 133 | 56 | 3.2 | 4.2 | 18.7 | 12.9 | 1.5 |
| Ex. 7 | 64 | 116 | 133 | 59 | 3.3 | 4.0 | 16.2 | 10.6 | 1.5 |
| Ex. 8 | 104 | 116 | 117 | 58 | 3.0 | 3.5 | 10.8 | 9.5 | 1.1 |
| Ex. 9 | 103 | 101 | 117 | 80 | 3.0 | 3.4 | 11.3 | 9.0 | 1.3 |
| Ex. 10 | 118 | 200 | 113 | 73 | 3.7 | 4.4 | 10.9 | 4.5 | 2.4 |
| Ex. 11 | 87 | 138 | 113 | 80 | 3.6 | 4.2 | 11.6 | 8.1 | 1.4 |
| Ex. 12 | 120 | 199 | 123 | 67 | 3.3 | 4.8 | 10.9 | 4.8 | 2.3 |
| Ex. 13 | 94 | 152 | 117 | 67 | 2.9 | 3.9 | 9.5 | 4.0 | 2.4 |
| Ex. 14 | 98 | 180 | 118 | 70 | 3.0 | 4.1 | 8.3 | 3.8 | 2.2 |
| Ex. 15 | 81 | 124 | 117 | 72 | 3.3 | 3.9 | 7.2 | 5.6 | 1.3 |
| Ex. 16 | 66 | 111 | 119 | 83 | 3.0 | 3.9 | 12.6 | 8.9 | 1.4 |
| Ex. 17 | 60 | 85 | 4 | 10 | 3.1 | 3.9 | 8.7 | 8.3 | 1.0 |
| Ex. 18 | 83 | 116 | 147 | 86 | 2.9 | 3.4 | 10.3 | 7.0 | 1.5 |
| Ex. 19 | 70 | 129 | 95 | 58 | 3.1 | 4.1 | 15.8 | 11.8 | 1.3 |

The coextruded films were measured for mechanical strength and tear resistance and the results were shown in Table 3. A typical BOPP film was included for comparison, which were obtained from a commercial clear BOPP film (Torayfan® YOR4/70G with a thickness of 17.5 μm made in standard BOPP production line). As expected, BOPP film showed much better mechanical properties outperforming that of biofilm samples. The PLA control sample (Ex. 1) showed the highest modulus in both MD and TD, which is the root cause of generating high noise observed for conventional BOPLA film. Examples 4 to 7, Example 11, and Examples 14 to 18 showed lower MD tensile strength due to their lower MDX (2.3 to 2.5), while Examples 16, 17 and 19 showed lower MD tensile strength more likely due to their higher heat set temperature.

The composite film in Example 17 has low tensile strength, extremely low elongation at break and low tear strength. The film is very brittle due to high heat set temperature, and it is not suitable for downstream processing.

As the two outer skin layers of the composite films were formulated with semi-crystalline PLA resin, the composite films showed high modulus as that observed for Examples 4 to 7, Example 10, and Example 12 due to the high Tg of PLA resin in the outer skin layer.

All film samples in Examples showed tear strength ratio MD/TD≥1 indicating good tear strength in machine direction except for Example 4 (low TDX) and Example 17 (probably due to too high heat set temperature). Examples 12 to 14 showed extremely high tear strength ratio MD/TD which could be resulted from the low heat set temperature 104° C. A biaxially oriented PHA-rich composite film has much better MD tear strength that of a blown PHA composite film which has ignorable orientation in TD.

All film samples in Examples showed lower moduli compared to that of BOPLA (Ex.1) since the low Tg of PHBV is about 2° C., much lower than the Tg of PLA resin (56° C.). Low Tg flexible biopolymers such as PBSA and PCL resins added into the outer skin layers can further reduce the moduli of the composite films. The moduli of the composite films can be further reduced if it is necessary by adding an amount of low Tg flexible biopolymers into the core layer, suitable biopolymers include such as PBSA, PCL and PBAT, low Tm PHA resins, and amorphous PHA resins.

As no Biomax SG 120 was added into the core layer as compatibilizer (Examples 10 to 19), the PHBV and PLA resins in the core layer still have good compatibility according to the mechanical properties of the composite films discussed earlier. It is believed that the transesterification reactions between PHBV and PLA occurred in-situ during extrusion process, forming PHBV-co-LA copolymer which works as compatibilizer between PHBV and PLA phases.

TABLE 4
Heat shrinkage of the biaxially oriented coextruded PHA-
rich composite films made in Examples (“Ex.”)

| | MD shrinakge (%) | | | TD shrinkage (%) | | |
|---|---|---|---|---|---|---|
| Example | 80° C. | 100° C. | 120° C. | 80° C. | 100° C. | 120° C. |
| BOPP | 0 | 0 | 0 | 0 | 0 | 0 |
| Ex. 1 | 2 | 4 | 6 | 2 | 4 | 10 |
| Ex. 2 | 4 | 7 | 12 | 7 | 16 | 24 |
| Ex. 3 | 2 | 5 | 8 | 7 | 13 | 20 |
| Ex. 4 | 6 | 8 | 42 | 21 | 28 | 33 |
| Ex. 5 | 4 | 6 | 10 | 15 | 23 | 29 |
| Ex. 6 | 1 | 2 | 5 | 4 | 9 | 16 |
| Ex. 7 | 1 | 2 | 3 | 2 | 4 | 8 |
| Ex. 8 | 5 | 9 | 13 | 19 | 29 | 31 |
| Ex. 9 | 3 | 6 | 10 | 5 | 12 | 18 |
| Ex. 10 | 3 | 7 | 12 | 8 | 17 | 27 |
| Ex. 11 | 1 | 1 | 3 | 1 | 3 | 7 |
| Ex. 12 | 3 | 6 | 13 | 9 | 20 | 31 |
| Ex. 13 | 3 | 7 | 12 | 9 | 21 | 32 |
| Ex. 14 | 3 | 6 | 12 | 10 | 22 | 33 |
| Ex. 15 | 1 | 1 | 3 | 2 | 5 | 10 |
| Ex. 16 | 1 | 1 | 1 | 1 | 1 | 3 |
| Ex. 17 | 0 | 1 | 1 | 0 | 0 | 0 |
| Ex. 18 | 2 | 4 | 8 | 4 | 8 | 16 |
| Ex. 19 | 1 | 2 | 4 | 2 | 4 | 7 |

Thermal stability of the biaxially oriented coextruded composite films was determined by measuring the heat shrinkage of the composite films made in Examples 1 to 19 at three temperatures 80° C., 100° C. and 120° C. for a duration time of 15 minutes as shown in Table 4 (The heat shrinkage of a BOPP film (YOR4/70G) was used herein for comparison). Firstly, BOPP film sample showed no heat shrinkage under the same test conditions due to polypropylene's high crystallinity (about 60 wt %), high melting temperature 160 to 165° C., and high heat set temperature (about 160° C.). At the conditions of an elevated temperature about 140° C. and a duration time 15 minutes, the BOPP film (YOR4/70G) has a MD shrinkage of 4 to 8% and a TD shrinkage of 2 to 5%. BOPLA control film also showed better thermal stability although it was stretched at 6 times in TD and heat set at 121° C. (which was relatively low heat set temperature for BOPLA). Among the processing parameters of orientation ratio, relaxation rate, and heat set temperature, the heat set temperature has the greatest influence on thermal stability for the same film formulation. The higher heat set temperature is applied to the composite film, the lower heat shrinkage (or higher heat resistance) can be achieved. However, for a specific resin or a composite film formulation, if the heat set temperature is over the up limit of optimal heat set temperature, the film will become very brittle, leading to film breaks in film making or downstream processes.

As the heat set temperature was increased from 82° C. to 127° C. in Examples 4 to 7, the heat shrinkage in MD at 120° C. was reduced from 42% to 3%, and TD heat shrinkage was reduced from 33% to 8%. The heat shrinkage of the composite film in Example 7 which was annealed 127° C. is comparable to that of Example 1 (BOPLA control film). High heat shrinkage at 120° C. that was observed for Examples 2 to 5, Examples 8 to 10 and Examples 12 to 14 are mainly resulted from their low heat set temperatures (in the range of 88° C. to 104° C.). As the heat set temperature of making the composite film was increased to the range of from 127 to 138° C. as that applied to Examples 7, 11, 15, 16, 18 and 19, the heat shrinkage of the composite films in both MD and TD at 120° C. is much lower, suggesting a much better heat resistance.

Preferably, to make low heat shrink/high heat resistance film with good thermal stability at processing conditions, the heat set temperature of making the PHA-rich composite films is in the range of from 125° C. to 140° C. If the heat set temperature is too high, the composite film will become brittle so that the composite film cold be difficult to process in film making or downstream processes. If the heat set temperature of making the PHA-rich composite films is too low, the film will have high heat shrinkage which are not suitable for the application with the processes of printing, coating, metallizing, and lamination.

However, a function of shrink film with high heat shrinkage rate is required for film application, lower heat set temperature in the range of from 80° C. to 110° C. is preferred in film making.

TABLE 5
Heat sealing and oxygen barrier properties of the coextruded
PHA-rich composite films made in Examples (“Ex.”)

| | Heat seal strength | | Hot tack strength | | Oxygen barrier |
|---|---|---|---|---|---|
| | SIT | Plateau | SIT | Plateau | (cc · mil/ |
| Example | (° F.) | (g/in) | (° F.) | (g/in) | 100 sq. in/day) |
| Ex. 1 | 193 | 438 | 195 | 505 | 77 |
| Ex. 2 | 189 | 458 | 193 | 250 | 43 |
| Ex. 3 | 187 | 415 | 195 | 263 | 38 |
| Ex. 11 | 182 | 519 | 183 | 517 | 32 |
| Ex. 14 | 160 | 596 | 162 | 346 | 43 |
| Ex. 15 | 162 | 610 | 160 | 429 | 31 |
| Ex. 18 | 160 | 620 | 163 | 413 | 41 |
| Ex. 19 | 162 | 456 | 160 | 331 | 37 |

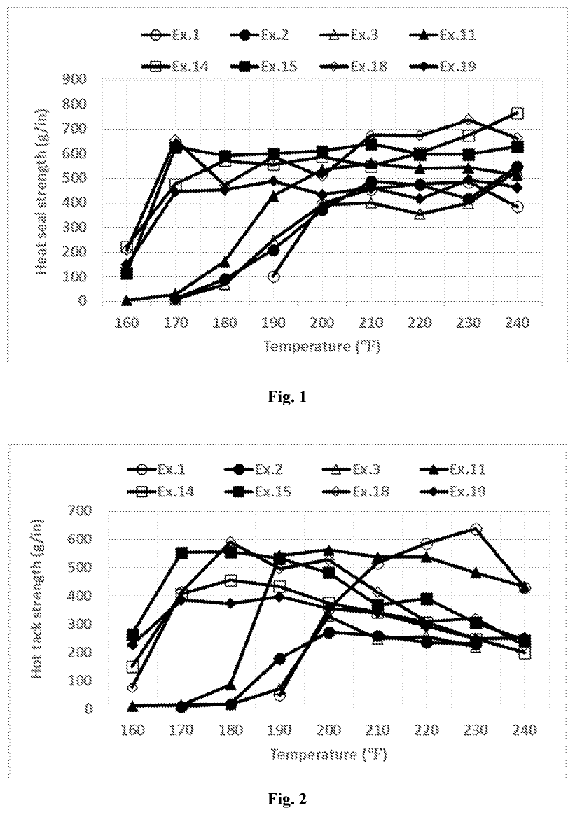

The heat seal and hot tack curves of the first outer layer (C) of the composite films in Examples 1, 2, 3, 11, 14, 15, 18, and 19 were drawn in FIGS. 1 and 2, respectively. The SIT and plateau strength of the curves of those composite films were presented in Table 5. The second outer layer (A) of some composite films in Examples are also heat sealable, but those were not discussed herein in details. Example 1 (Ex.1), as shown Table 1, BOPLA film with amorphous PLA resin LX975 in the sealant layer showed a SIT of 193° F. obtained from its heat seal curve and a SIT of 195° F. obtained from its hot tack curve. SIT is defined as the seal temperature at which gives 200 Win (grams per inch) seal strength or hot tack strength. The plateau strength on average was at about at 438 Win for heat sealing and 505 Win for hot tack. In comparison, the heat sealant layer of the composite films in Examples 2 (comprising 60 wt % Y1000P in the core layer) and Example 3 (comprising 70% Y1000P in the core layer) having about the same sealant recipe as the BOPLA control film (Ex.1) showed slightly lower SIT but similar plateau strength to that of the BOPLA control film except for the hot tack strength was only about 50% of the BOPLA film. Biomax SG 120 in the core layer did not change the heat sealing performance. Increasing the loading of Y1000P from 60 wt % to 70 wt % in the core layer also did not significantly change the heat sealing properties.

The sealant layer of the composite film in Example 11 (Ex. 11) comprising 20 wt % polycaprolactone CAPA®6500D showed significant improvement in SIT and plateau strength compared to that of Example 2 and 3. The heat sealant layer (C) showed a SIT at 182° F. and a plateau strength about 517 Win

The heat sealant layer of the composite films in Examples 14, 15 and 18 (Ex.14, Ex.15 and Ex.18) comprised about 6% wt % PLA10A, 10 wt % CAPA®6500D, 24 wt % LX975 and 60 wt % FD92PM resins as shown in Table 1. Certified home compostable FD92PM was used to further improve both home compostability and heat sealability of the outer layers of the composite film. Those film samples showed further significant improvement in both SIT as low as about 160° F. and plateau seal strength as high as 600 Win. Those three samples showed very comparable heat sealing performance since they have the same recipe used in heat sealant layer. The hot tack strength performed slightly different due to the difference in the content of PLA resin in the core layer, a higher PLA content is more favorable to achieve a higher hot tack strength.

The composite film in Example 19 showed lower plateau strength for both heat sealing and hot tack although it has the same recipe as that in Examples 14, 15 and 18, it could likely be resulted from a higher heat set temperature applied to the composite film.

The composite films in Examples 13, 14, 18 and 19 were made to comprise high percentage of TUV certified home compostable biopolymers for improving home compostability. In addition, CAPA®6500D and FD92PM are low Tg flexible semi-crystalline biopolymers, both can have excellent effects on noise dampening as they are added into the core layer and out skin layers. FD92PM has a higher melting peak more suitable for the outer skin layers required for better heat resistance.

Low Tg flexible biopolymers including PBSA, PCL and amorphous PHA resins can be added into the core layer at an amount of about 5 wt % to 25 wt % of the total weight of the core layer to further improve the hermeticity (high plateau seal strength) of the composite films.

Using TUV-certified home-compostable low Tg flexible biopolymers PBSA and PCL together with PLA resins including semi-crystalline PLA, amorphous PLA, and PLA copolymers in the outer skin layer, the heat seal and hot tack can be significantly improved to achieve SIT as low as 160° F., plateau strength as high as 600 On, and a broadened heat seal temperature range of from 160 to 240° F.

The oxygen barrier of the composite films listed in Table 5 was measured and normalized to the barrier data of one mil thickness film (25 microns) for comparison. It is noted that the biaxially oriented composite film samples showed much better oxygen barrier (31 to 43 cc·mil/100 in2/day) compared to that (77 cc·mil/100 in2/day) of BOPLA control film (Ex. 1). The barrier data among the composite films with Y1000P PHBV resin in the core layer showed no significant difference in terms of barrier data range, the variations observed are more likely due to the changes in processing conditions but not the change in formulation.

TABLE 6
Optical properties and coefficient of friction of the coextruded
composite films made in Examples (“Ex.”)

| Exam- | Gloss | | Haze | COF, A/A | | COF, A/C | | COF, C/C | |
|---|---|---|---|---|---|---|---|---|---|
| ple | A/60° | C/20° | % | μs | μd | μs | μd | μs | μd |
| Ex. 1 | 122 | 92 | 2 | 1.82 | 0.70 | 0.64 | 0.66 | 0.56 | 0.53 |
| Ex. 2 | 98 | 42 | 22 | 0.74 | 0.70 | 0.70 | 0.65 | 0.69 | 0.62 |
| Ex. 3 | 80 | 37 | 46 | 0.64 | 0.65 | 0.62 | 0.64 | 0.64 | 0.67 |
| Ex. 4 | 73 | 21 | 63 | 0.74 | 0.69 | 0.75 | 0.69 | 0.76 | 0.69 |
| Ex. 5 | | | | | | | | | |
| Ex. 6 | | | | | | | | | |
| Ex. 7 | | | | | | | | | |
| Ex. 8 | 92 | 32 | 44 | 0.78 | 0.68 | 0.67 | 0.65 | 0.64 | 0.60 |
| Ex. 9 | 82 | 25 | 54 | 0.69 | 0.66 | 0.65 | 0.64 | 0.62 | 0.62 |
| Ex. 10 | 107 | 68 | 28 | 0.73 | 0.68 | 0.68 | 0.67 | 0.65 | 0.64 |
| Ex. 11 | 96 | 30 | 47 | 0.58 | 0.59 | 0.42 | 0.50 | 0.37 | 0.42 |
| Ex. 12 | 111 | 77 | 14 | 0.67 | 0.64 | 0.66 | 0.64 | 0.64 | 0.69 |
| Ex. 13 | 94 | 24 | 23 | 0.77 | 0.86 | 0.70 | 0.83 | 0.69 | 0.83 |
| Ex. 14 | 57 | 7 | 41 | 0.44 | 0.50 | 0.51 | 0.61 | 0.51 | 0.59 |
| Ex. 15 | 21 | 7 | 56 | 0.60 | 0.61 | 0.55 | 0.64 | 0.62 | 0.71 |
| Ex. 16 | 20 | 8 | 50 | 0.63 | 0.66 | 0.55 | 0.61 | 0.61 | 0.68 |
| Ex. 17 | 21 | 8 | 27 | 0.76 | 0.82 | 0.71 | 0.77 | 0.69 | 0.80 |
| Ex. 18 | 42 | 8 | 35 | 0.87 | 0.96 | 0.52 | 0.63 | 0.38 | 0.41 |
| Ex. 19 | 67 | 6 | 35 | 0.79 | 0.90 | 0.71 | 0.83 | 0.54 | 0.58 |

Optical properties of the coextruded film samples are shown in Table 6. The BOPLA control sample (Ex. 1) showed the lowest haze at about 2%, and highest gloss for both A side (cast side or drum side) and C side (sealant side or air side). As the core layer and the second outer skin layer in Example 2 were changed to a PHA-rich biodegradable composite resin (Ex. 2), the haze was increased sharply from 2% to 22%, and the glosses for A side and B side were also reduced to a lower level. As Y1000P in the core layer was increased to 70 wt %, the haze of the composite film in Example 3 was increased from 22% to 46%, the glosses were also reduced.

PHBV resin (Y1000P) is immiscible with PLA resin in the core layer, forming two different separate phases, and a boundary is formed between two phases with different refractive index. Large PHBV crystals can form in the core layer, and they can be one of the factors of high haze. As a result, high haze was observed the PHA-rich composite films as Y1000P is the PHA resin. Low gloss values for the outer surfaces could be due to the higher surface roughness resulted from the immiscibility between Y1000P PHBV and PLA resins in the core layer. Examples 4 to 9 having Biomax SG 120 as compatibilizer in the core layer showed similar optical properties to that of Example 3. The optical properties of the composite films in Examples 5 to 7 were not measured since those have the same formulation as that in Example 4, however, the haze value was observed to decrease with increasing heat set temperature, the size of polymer crystals became smaller with increasing heat set temperature (refer to the haze data in Examples 15 to 17).

As the outer layer formulations in Examples 13 to 19 were changed to improve home compostability and heat sealability using TUV-certified home-compostable flexible biopolymers, the glosses of the outer layers decreased, and the surface of the composite films showed a matte finish. As Biomax SG 120 was removed from the core layer, there is no significant difference in optical properties observed for Examples 10 to 19, compared to those composite film samples with 3 wt % to 5 wt % Biomax SG 120 in the core layer in Examples 2 to 9.

The COFs of the cast side (A side) and air side (C side) of the coextruded composite film samples were measured and shown in Table 6. The “COF, A/A” is the COF of the cast side to cast side (A to A); the “COF, A/C” is the COF of cast side to air side (A to C); the “COF, C/C” is the COF of air side to air side (C to C). The cast side of the film sample in Example 1 showed the highest COF due to its low content in JC-30 antiblock (150 ppm). The sealant layer (air side) of the composite film in Example 1 comprises 3000 ppm of JC-30 antiblock and showed static and dynamic COF of 0.56 and 0.53, respectively. The suitable amount of antiblocks or slip additives used in the outer layers varies with the crystallinity and Tg of the biopolymers in the outer layers as well as the final application of the composite films. For a soft, tacky, and flexible skin layer, it needs a higher loading of antiblock and slip additives to meet the requirements for processing and applications. The inventive composite films in Examples showed static and dynamic COFs suitable for downstream processing and packaging film handling.

### Test Methods

The various properties in the above examples were measured by the following methods:

Transparency of the film was measured by measuring the haze of a single sheet of film using a haze meter model like a BYK Gardner “Haze-Gard Plus®” substantially in accordance with ASTM D1003.

Gloss of the film was measured by measuring the desired side of a single sheet of a film by a surface reflectivity gloss meter (BYK Gardner Micro-Gloss) substantially in accordance with ASTM D2457. The A-side or non-sealable layer side was measured at a 60° angle; the sealant layer side was measured at a 20° angle.

Heat seal strength was measured using a LAKO™ Heat Sealer (model SL10) at 30 PSI, 0.5 second dwell time, and 15 second delay time before automatically testing the seal strength. The automated LAKO™ Heat Sealer is capable of forming a film seal, determining the seal strength, and generating a seal profile from a test film sample.

Hot tack strength was measured by using a LAKO™ Tool hot tack/sealer model SL10 at 30 PSI, 0.5 second dwell time, with heated flat Teflon coated lower seal jaw, and unheated upper seal jaw and with a delay time set to 0 seconds for hot tack testing.

Seal initiation temperature (SIT): SIT was measured by using the above methods (A) and (B) using the LAKO Heat Sealer or LAKO™ Tool SL10 hot tack sealer. SIT is the lowest temperature at which 200 g/in seal strength or hot tack strength is achieved.

COF of the outer skin layers of the coextruded composite films made in Examples was measured under ambient temperature condition to determine the static and dynamic COF (μs and μd) using the method of ASTM D1894.

Mechanical properties of the coextruded composite films were tested under ambient temperature condition using the method of ASTM D882.

Tear resistance of the coextruded composite film was measured substantially accordance with ASTM D1922-09. Three samples each are cut from the plastic film samples in the machine direction (MD) and in the transverse direction (TD) for testing and data collection.

Heat shrinkage of the coextruded composite films was measured substantially in accordance with ASTM D1204 except that the measurement condition was at three temperature levels of 80° C., 100° C. and 120° C., respectively, for a process duration time of 15 minutes.

Oxygen transmission rate (O2TR) of the composite films was directly measured by using a Mocon Oxtran 2/20 unit substantially in accordance with ASTM D3985.

Home compostability of the coextruded biodegradable composite film is being evaluated in the home compost under the conditions specified in ASTMD5338-15 except the composting temperatures are controlled in the range 28±5° C. (AS 5810-2010 or “OK COMPOST HOME—CERTIFICATION, 2019 VERSION”).

This application discloses several numerical ranges in the text, tables and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown in the description, but is to be accorded the widest scope consistent with the principles and features disclosed herein.

### REFERENCES

All references, including granted patents and patent application publications, referred herein are incorporated herein by reference in their entirety.

1. A biaxially oriented multi-layer composite film comprising a film comprising PHA-rich core layer (B) and a layer (C);
wherein the layer (B) comprises a PHA-rich core layer comprising a PHA resin and a modifier X, wherein an amount of PHA resin in the core layer is more than 50 wt % of a total weight of the core layer; wherein the modifier X is less than 50 wt % of the total weight of the core layer and is a non-PHA with a glass transition temperature of Tg≤60° C.;
wherein the layer (C) comprises a PLA resin and a modifier Y; wherein the PLA resin is at an amount of about 5 wt % to 80 wt % of a total weight of the layer (C) and the modifier Y has a glass transition temperature of Tg≤0° C. and a peak melting temperature of 56° C.≤Tm≤90° C.;
wherein the film has a seal initiation temperature of about 160° F. and a heat seal temperature window of from 160° F. to 240° F.; wherein the film is biodegradable and home compostable as per AS 5810-2010 standard at a temperature 28±5° C.

2. The film of claim 1, wherein the PHA resin in the core layer comprises a semi-crystalline PHA resin or amorphous PHA resin or mixtures thereof.

3. The film of claim 2, wherein the PHA resin comprises at least 40 wt % of the semi-crystalline PHA resin of the total weight of the core layer.

4. The film of claim 1, wherein the modifier Y is in a range of about 20 wt % to 95 wt % of the total weight of the layer (C).

5. The film of claim 2, wherein the semi-crystalline PHA resin has a glass transition temperature of Tg≤10° C. and a melting temperature of 120° C.≤Tm≤180° C.

6. The film of claim 1, wherein the modifier X has a glass transition temperature of Tg≤60° C. and a melting temperature of 56° C.≤Tm≤155° C.

7. The film of claim 1, wherein the modifier X comprises PBS, PBSA, PCL, PBAT, PLA, PLA copolymers or mixtures thereof.

8. The film of claim 1, the core layer comprises low Tg flexible biopolymers including PBSA, PCL and amorphous PHA resin or mixtures thereof in an amount of about 5 wt % to 25 wt % of the total weight of the core layer to improve heat sealing hermeticity.

9. The film of claim 7, wherein the PLA copolymers comprise PLA-co-3HP, PLA-co-6-CL and PLA-co-GA or mixtures thereof.

10-11. (canceled)

12. The film of claim 1, wherein the modifier X further comprises inorganic particles and/or slip additives or mixtures thereof.

13. (canceled)

14. The film of claim 1, wherein the PLA resin in the layer (C) comprises a semi-crystalline PLA resin, an amorphous PLA resin, and a PLA copolymer resin or mixtures thereof.

15. The film of claim 14, wherein the semi-crystalline PLA resin in the layer (C) is at an amount of less than 30 wt % of the total weight of the layer (C).

16. The film of claim 14, wherein the semi-crystalline PLA resin has Tm of about 145° C. to 155° C. and Tg less than 60° C.

17. The film of claim 1, wherein the modifier Y comprises polybutylene succinate-co-adipate (PB SA) and polycaprolactone (PCL) or mixtures thereof.

18. The film of claim 17, wherein an amount of the PCL is about 0 wt % to about 30 wt % of the total weight of the layer (C).

19. The film of claim 17, wherein an amount of the PB SA is about 20 wt % to about 95 wt % of the total weight of the layer (C).

20. The film of claim 1, wherein the film further comprises a second outer skin layer (A).

21-24. (canceled)

25. The film of claim 1, wherein the layer (C) is a heat sealant layer.

26-36. (canceled)

37. The film of claim 1, wherein the film has tear strength ratio of MD/TD≥1 as measured according to ASTM D1922-09.

38. The film of claim 1, wherein total crystallinity of polymers in the core layer of the film is more than 40 wt %.
